(19) United States
(12) Patent Application Publication
(10) Pub. No.: US 2020/0346494 A1
(43) Pub. Date: Nov. 5, 2020

(54) Reinforcing Ply for Articles Consisting of an Elastomeric Material, and Vehicle Pneumatic Tires

(71) Applicant: Continental Reifen Deutschland GmbH, Hannover (DE)

(72) Inventors: Thomas Kramer, Herford (DE); Joern Krueger, Mandelbachtal (DE); Carole Justine, Scharrel (DE); Guenter Wahl, Hohenhameln (DE)

(73) Assignee: Continental Reifen Deutschland GmbH, Hannover (DE)

(21) Appl. No.: 16/960,899

(22) PCT Filed: Dec. 3, 2018
(86) PCT No.: PCT/EP2018/083257

§ 371 Date: Jul. 9, 2020

(30) Foreign Application Priority Data
Jan. 16, 2018 (DE) 10 2018 200 631.8

(51) Int. Cl. B60C 9/00; D07B 1/02; B60C 9/20

(52) U.S. Cl. CPC B60C 9/00; D07B 1/02; B60C 9/20; D07B 2501/2046; B60C 2009/0425; B60C 2009/0035; B60C 2009/0092; B60C 2009/0085; D07B 2205/103

(57) ABSTRACT

The invention relates to a rubberized reinforcing ply (1) for articles consisting of an elastomeric material, preferably for vehicle tires, wherein the reinforcing ply (1) has a multiplicity of textile strengthening members (2) which are arranged parallel to and spaced apart from one another, wherein each textile strengthening member (2) is composed of at least one twisted multifilament yarn composed of the material viscose. The reinforcing ply (1) satisfies the following condition: (D²/E₀) in mm corresponds to a value in a range from 0.30 mm to 0.45 mm, and the reinforcing ply (1) has a strength of 11 kN/dm<x<20 kN/dm, where D is the diameter of the textile strengthening member (2) in mm and lies in a range from 0.38 mm to 0.48 mm, and where E₀=100/epdm.

The invention relates to a rubberized reinforcing ply for articles consisting of an elastomeric material, preferably for vehicle tires, wherein the reinforcing ply has a multiplicity of textile strengthening members which are arranged parallel to and spaced apart from one another, wherein each textile strengthening member is composed of at least one twisted multifilament yarn composed of the material viscose. The invention further relates to a vehicle pneumatic tire.

Reinforcing plies for articles consisting of an elastomeric material such as, for example, industrial rubber products and vehicle (pneumatic) tires are extremely important and are generally known to a person skilled in the art. The reinforcing plies have a multiplicity of reinforcing, thread-shaped elements, referred to as the strengthening members. They are embedded completely in elastomeric material. The strengthening members of these reinforcing plies have the form, for example, of fabrics or of calendered, continuously coiled strengthening members.

The rubberized reinforcing plies of suitable size and design are joined to further components in order to form an industrial rubber product or a vehicle pneumatic tire. Here, the rubberized reinforcing plies reinforce the product in question.

A reinforcing ply having textile cords made up of multifilament yarns composed of PET, PEN and aramid has been disclosed in EP 0 908 329 B1. Owing to the yarn linear density used and the construction of the PEN cords, they are comparatively thin, and so the rubberized reinforcing ply has a comparatively low ply thickness. This firstly has the advantage that less rubber material has to be used for rubberizing of these strengthening members, which saves material costs. Secondly, a thin rubberized reinforcing ply in the product, for example in the vehicle tire, has the advantage that the weight of the tire is reduced and produces a lower hysteresis, which has a positive effect on the rolling resistance of the tire.

WO 2014118082 A1 discloses a strengthening member for elastomeric products composed of one or more environmentally friendly viscose multifilament yarns which have a comparatively small diameter, a degree of crystallinity in the range from 15% to 40% and a tensile strength in the range from ≥45 cN/tex to ≤55 cN/tex.

However, in addition to the weight reduction and the lower hysteresis owing to a thin ply thickness, the strength of this reinforcing ply is also essential in order to be able to sufficiently take up the forces occurring in the tire.

It is therefore an object of the invention to provide a reinforcing ply for articles consisting of an elastomeric material, which reinforcing ply is of comparatively thin form and nevertheless has sufficient strength for the forces which occur in the tire. It is a further object of the invention to provide a vehicle pneumatic tire which, while having good structural durability, is optimized in terms of rolling resistance.

The object is achieved with regard to the reinforcing ply in that the reinforcing ply satisfies the following condition:
(D²/E₀) in mm corresponds to a value in a range from 0.30 mm to 0.45 mm, and in that the reinforcing ply has a strength of 11 kN/dm<x<20 kN/dm, where D is the diameter of the textile strengthening member in mm and lies in a range from 0.38 mm to 0.48 mm, and where E₀=100/epdm.

A reinforcing ply is created which has strengthening members with comparatively small diameters. The diameters of the strengthening members are combined with the density of their arrangement in the reinforcing ply and their strength in such a way that an optimized strength of the reinforcing ply is obtained. The rubberizing of the reinforcing ply, in particular its thickness, is configured in a manner which is customary to a person skilled in the art, with the result that a comparatively thin reinforcing ply is made available. This reinforcing ply has a strength of 11 kN/dm<x<20 kN/dm, which is a sufficient strength for reinforcing plies with textile strengthening members, in particular for passenger car tires.

The term “epdm” means ends per decimeter and describes the strengthening member density in the reinforcing ply.

The expression “strength of the reinforcing ply” means the breaking force of the reinforcing ply in kN per dm (decimeter), which is calculated from the breaking force of the individual strengthening member multiplied by the number of strengthening members per dm of this reinforcing ply, with the breaking force being determined in accordance with ASTM D885M.

It is advantageous if the strengthening member is a cord composed of two twisted-together viscose multifilament yarns and if the strengthening members are arranged in this reinforcing ply in a density in a range from 150 epdm to 220 epdm, preferably in a range from 170 epdm to 195 epdm. The aforementioned density is an optimized compromise between durability of the reinforcing ply and force transmission, for which a specific rubber volume must be present between the strengthening members, on the one hand, and the strength and the tire performance durability, on the other hand, for which the strengthening members must not lie too far apart in the reinforcing ply.

It is expedient if the viscose multifilament yarn a degree of crystallinity in the range from 15% to 40%, preferably in the range from 20% to 35%, particularly preferably in the range from 24% to 30%, and, after conditioning in standard atmosphere in accordance with DIN EN ISO 139-1:2005, a yarn linear density in the range from ≥150 dtex to ≤1100 dtex, preferably in the range from ≥200 dtex to ≤840 dtex, particularly preferably in the range from ≥200 dtex to ≤820 dtex.

The production, properties, constructions and the advantages of a reinforcing ply having environmentally friendly configured and treated strengthening members with at least one such viscose multifilament yarn and of vehicle pneumatic tires having an aforementioned reinforcing ply are described in WO 2014118082 A1, in particular on page 4, line 28 to page 15, line 25, the content of which is hereby incorporated in this application.

In one specific embodiment of the invention, the reinforcing ply satisfies the following condition:
(D²/E₀) in mm corresponds to a value in a range from 0.37 mm to 0.45 mm, and the reinforcing ply has a strength of 16 kN/dm<x<19 kN/dm, where D is the diameter of the textile strengthening member in mm and lies in a range from 0.43 mm to 0.48 mm, preferably in a range from 0.45 mm to 0.46 mm, and where E₀=100/epdm.

Such an embodiment of a textile cord is particularly expedient for the construction 780 dtex×2, wherein both yarns are composed of the material viscose. An optimum compromise between required ply strength and smallest possible ply thickness is obtained.

In one specific alternative embodiment of the invention, the reinforcing ply satisfies the following condition:
(D²/E₀) in mm corresponds to a value in a range from 0.35 mm to 0.45 mm, and the reinforcing ply has a strength of 11 kN/dm<x<14 kN/dm, where D is the diameter of the textile strengthening member in mm and lies in a range from 0.40 mm to 0.43 mm, and where E₀=100/epdm.

Such an embodiment of a textile cord is particularly expedient for the construction 620 dtex×2, wherein both yarns are composed of the material viscose. An alternative compromise between required ply strength and smallest possible ply thickness by comparison with the aforementioned exemplary embodiment is obtained.

In one embodiment of the invention, the textile cord is asymmetrical and has multifilament yarns of differing yarn linear density, wherein the construction is preferably 620 dtex×1/780 dtex×1 [600 tpm/550 tpm], and wherein the cord is end-twisted in the opposite direction to the yarn twist direction.

In one advantageous embodiment of the invention, the cord composed of viscose multifilament yarns has the construction 620 dtex×2 with a diameter of 0.42 mm, wherein the cord is arranged in the reinforcing ply in a density of 200 epdm, and wherein the reinforcing ply has a strength of approximately 13.2 kN/dm.

In a further advantageous embodiment of the invention, the cord composed of viscose multifilament yarns has the construction 780 dtex×2 with a diameter of 0.46 mm, wherein the cord is arranged in the reinforcing ply in a density of 175 epdm, and wherein the reinforcing ply has a strength of approximately 16.1 kN/dm.

With regard to the vehicle pneumatic tire, the invention is achieved in that said tire has at least one above-described reinforcing ply.

This reinforcing ply is a carcass and/or a belt bandage and/or a bead reinforcer. This reinforcing ply is preferably a carcass of a passenger car pneumatic tire.

In one specific embodiment of the invention, the vehicle pneumatic tire has, in addition to the above-described reinforcing ply, which is preferably a carcass, a belt ply composed of rubberized strengthening members, which satisfies the following condition:
(D²/E₀) in mm corresponds to a value in a range from 0.07 mm to 0.43 mm, and the reinforcing ply has a strength of 16.5 kN/dm<X<55 kN/dm, preferably of 22 kN/dm<X<38 kN/dm, where D is the diameter of the strengthening member in mm, and where E₀=100/epdm.

It is expedient if the sum of the strengths of the reinforcing ply with textile strengthening members and of the belt ply is ≥40 kN/dm. A sufficient overall strength is obtained.

The strengthening member of the belt ply is preferably composed of at least one steel filament which has a diameter in a range from 0.26 mm to 0.35 mm. These thin diameters are advantageous for an optimized rolling resistance.

In one preferred embodiment of the invention, the strengthening member has the construction 1×0.30 mm or 2×0.30 mm and is arranged in the belt ply in a density in a range from 80 to 120 epdm. The aforementioned density is an optimized compromise between durability of the reinforcing ply and force transmission, for which a specific to rubber volume must be present between the strengthening members, on the one hand, and the strength and the tire performance durability, on the other hand, for which the strengthening members must not lie too far apart in the reinforcing ply.

A steel monofilament of the construction 1×0.30 mm with a density of 110 epdm is preferably arranged in the belt ply, wherein this belt ply has a strength of approximately 24 kN/dm.

In another preferred embodiment, a steel cord of the construction 2×0.30 mm with a density of 80 epdm is arranged in the belt ply, wherein this belt ply has a strength of approximately 35 kN/dm.

The invention will be explained in more detail below with reference to a figure which illustrates a schematic exemplary embodiment of the invention.

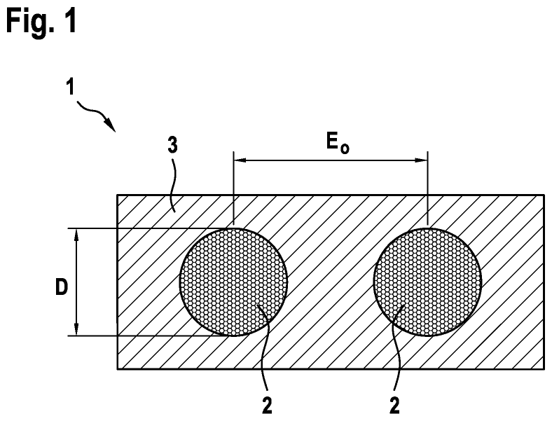

FIG. 1 shows a detail of the cross section of a reinforcing ply according to the invention for passenger car vehicle pneumatic tires.

The reinforcing ply 1 is a carcass ply. The reinforcing ply 1 has a multiplicity of textile strengthening members 2 which are arranged parallel to and spaced apart from one another and which are embedded in a rubber matrix 3. Of the strengthening members 2, two strengthening members 2 are illustrated in the detail of FIG. 1. Each textile strengthening member 2 is a cord 2 of the construction 780 dtex×2 that is composed of two twisted-together multifilament yarns. The multifilament yarns are composed of the environmentally friendly configured and treated material viscose. Each viscose multifilament yarn has a degree of crystallinity in the range from 20% to 35%, preferably in the range from 24% to 30%, and, after conditioning in standard atmosphere in accordance with DIN EN ISO 139-1:2005, has a yarn linear density in the range from ≥200 dtex to ≤840 dtex, and a tensile strength in the range from ≥45 cN/tex to ≤55 cN/tex, preferably in the range from ≥48 cN/tex to ≤53 cN/tex. Two viscose multifilament yarns are thus twisted to form a cord 2. Each viscose multifilament yarn is twisted in the same direction with a twist of 550, whereas the end twisting likewise has a twist of 550, but in the opposite direction. The diameter of the cord D is 0.46 mm, and the cord 2 is arranged in the reinforcing ply 1 with 175 epdm. (D²/E₀) in mm corresponds to 0.37 mm. The reinforcing ply has a strength of 16.1 kN/dm.

### LIST OF REFERENCE NUMERALS

1 Reinforcing ply

2 Textile strengthening member / cord

3 Rubber matrix

D Diameter of the cord

E₀ Distance between the center points of two adjacent cords in cross section

1.-16. (canceled)

17. A vehicle pneumatic tire comprising at least one rubberized reinforcing ply, wherein the at least one rubberized reinforcing ply comprises an elastomeric material, a multiplicity of textile strengthening members which are arranged parallel to and spaced apart from one another, and wherein each textile strengthening member of the multiplicity of textile strengthening members is composed of at least one twisted multifilament viscose yarn;
wherein the at least one rubberized reinforcing ply has a ratio of D²/E₀ in a range of from 0.30 mm to 0.45 mm, wherein D is the diameter of each textile strengthening member which lies in a range from 0.38 mm to 0.48 mm, and wherein E₀=100/epdm;
wherein the at least one rubberized reinforcing ply has a strength in the range of from greater than 11 kN/dm to less than 20 kN/dm;
wherein the at least one rubberized reinforcing ply is comprised in one or more of a carcass, a belt bandage or a bead reinforcer of the vehicle pneumatic tire;
the vehicle pneumatic tire further comprising a belt ply composed of rubberized strengthening members, wherein the belt ply has a ratio of D²/E₀ in a range of from 0.07 mm to 0.43 mm and a strength in the range of from greater than 16.5 kN/dm to less than 55 kN/dm, wherein D is the diameter of each strengthening member of the rubberized strengthening members in mm units, and wherein E₀=100/epdm; and,
wherein a sum of the strength of the at least one rubberized reinforcing ply textile and the strength of the belt ply is at least 40 kN/dm.

18. The vehicle pneumatic tire as claimed in claim 17, wherein each textile strengthening member of the multiplicity of textile strengthening members is a cord composed of two twisted-together viscose multifilament yarns, and wherein the multiplicity of textile strengthening members are arranged in the at least one rubberized reinforcing ply with a density in a range from 170 epdm to 195 epdm.

19. The vehicle pneumatic tire as claimed in claim 17, wherein the at least one twisted viscose multifilament yarn a has degree of crystallinity in the range from 15% to 40%, and, after conditioning in standard atmosphere in accordance with DIN EN ISO 139-1:2005, a yarn linear density in the range of from 150 dtex to <1100 dtex.

20. The vehicle pneumatic tire as claimed in claim 17, wherein the at least one rubberized reinforcing ply has a ratio of D²/E₀ in a range of from 0.37 mm to 0.45 mm, wherein D lies in a range from 0.43 mm to 0.48 mm and E₀=100/epdm, and wherein the at least one rubberized reinforcing ply has a strength in the range of from greater than 16 kN/dm to less than 19 kN/dm.

21. The vehicle pneumatic tire as claimed in claim 17, wherein the at least one rubberized reinforcing ply has a ratio of D²/E₀ in a range of from 0.35 mm to 0.45 mm, wherein D lies in a range from 0.40 mm to 0.43 mm and E₀=100/epdm, and wherein the at least one rubberized reinforcing ply has a strength in the range of from greater than 11 kN/dm to less than 14 kN/dm.

22. The vehicle pneumatic tire as claimed in claim 20, wherein each of the textile strengthening members is textile cord having the construction of 780 dtex×2, and wherein the textile cord is composed of two twisted-together viscose multifilament yarns.

23. The vehicle pneumatic tire as claimed in claim 21, wherein each of the textile strengthening members is textile cord having the construction of 620 dtex×2, and wherein the textile cord is composed of two twisted-together viscose multifilament yarns.

24. The vehicle pneumatic tire as claimed in claim 17, wherein each of the textile strengthening members is a textile cord, wherein the textile cord is asymmetrical and has multifilament yarns of differing yarn linear density, wherein the textile cord has a construction 620 dtex×1/780 dtex×1 [600 tpm/550 tpm], and wherein the textile cord is end-twisted in an opposite direction to a yarn twist direction.

25. The vehicle pneumatic tire as claimed in claim 23, wherein the textile cord has the construction of 620 dtex×2 with a diameter (D) of 0.42 mm, wherein the textile strengthening members are arranged in the at least one rubberized reinforcing ply at a density of 200 epdm, and wherein the at least one rubberized reinforcing ply has a strength of approximately 13.2 kN/dm.

26. The vehicle pneumatic tire as claimed in claim 22, wherein the textile cord has the construction of 780 dtex×2 with a diameter (D) of 0.46 mm, wherein the textile strengthening members are arranged in the at least one rubberized reinforcing ply at a density of 175 epdm, and wherein the at least one rubberized reinforcing ply has a strength of approximately 16.1 kN/dm.

27. The vehicle pneumatic tire as claimed in claim 23, wherein each strengthening member of the belt ply is composed of at least one steel filament which has a diameter in a range from 0.26 mm to 0.35 mm.

28. The vehicle pneumatic tire as claimed in claim 17, wherein each strengthening member of the belt ply has a construction of 1×0.30 mm or 2×0.30 mm, wherein the textile strengthening members are arranged in a density in a range of from 80 to 120 epdm.
